(19) United States
(12) Patent Application Publication
(10) Pub. No.: US 2019/0368911 A1
(43) Pub. Date: Dec. 5, 2019

(54) LIQUID LEVEL SENSOR CIRCUIT

(71) Applicant: HEWLETT-PACKARD DEVELOPMENT COMPANY, L.P., Spring, TX (US)

(72) Inventors: Chien-Hua Chen, Corvallis, OR (US); William R. Boucher, Corvallis, OR (US); Michael W. Cumbie, Corvallis, OR (US)

(73) Assignee: HEWLETT-PACKARD DEVELOPMENT COMPANY, L.P., Spring, TX (US)

(21) Appl. No.: 16/481,554

(22) PCT Filed: Mar. 14, 2017
(86) PCT No.: PCT/US2017/022237

§ 371 Date: Jul. 29, 2019

(51) Int. Cl. G01F 23/26; G01F 23/24; B41J 2/175

(52) U.S. Cl. CPC G01F 23/268; B41J 2002/17589; B41J 2/17566; G01F 23/24

(57) ABSTRACT

A liquid level sensor circuit for measuring a liquid level in the reservoir comprising two electrodes extending into the reservoir along at least part of a height of the reservoir down to a base of the reservoir, wherein the liquid level sensor circuit is arranged to have increased sensitivity near the base.

### BACKGROUND

A liquid level sensor circuit is discussed, for liquid supplies as used in two and three dimensional liquid dispense systems. The liquid supply may be a replaceable supply suitable to be connected to and disconnected from the liquid dispense system. Many of such liquid supplies are provided with liquid level sensor circuits.

### DRAWINGS

FIG. 1 illustrates a diagram of an example of a liquid supply and a liquid level sensor circuit in a first state.

FIG. 2 illustrates a diagram of the example liquid supply and liquid level sensor circuit of FIG. 1 in a second state.

FIG. 3 illustrates an example of a graph that plots conductance to ink level as measured with an example liquid level sensor circuit.

FIG. 4 illustrates a diagram of another example of a liquid supply with a liquid level sensor circuit.

FIG. 5 illustrates a cross section of an example of a reservoir with a liquid level sensor circuit.

FIG. 6 illustrates a cross section of another example of a reservoir with a liquid level sensor circuit.

FIG. 7 illustrates a cross section of yet another example of a reservoir with a liquid level sensor circuit.

FIG. 8 illustrates a cross section of yet another example of a reservoir with a liquid level sensor circuit.

FIG. 9 illustrates a cross section of yet another example of a reservoir with a liquid level sensor circuit.

FIG. 10 illustrates a cross section of yet another example of a reservoir with a liquid level sensor circuit.

FIG. 11 illustrates a diagram of an example of a liquid level sensor circuit and a base of a reservoir.

FIG. 12 illustrates a diagram of another example of a liquid level sensor circuit and a base of a reservoir.

FIG. 13 illustrates a diagram of yet another example of a liquid level sensor circuit and a base of a reservoir.

### DESCRIPTION

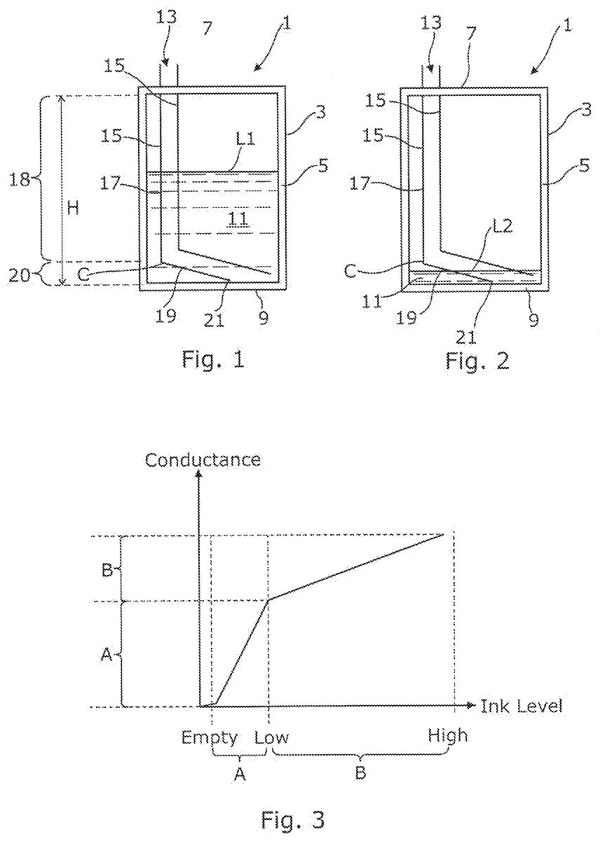

FIGS. 1 and 2 illustrate a liquid supply 1. The liquid supply 1 is to supply liquid to a further liquid dispense system. For example the liquid supply 1 may be a replaceable cartridge. The liquid dispense system may be a 2D or 3D print system. The liquid may be an ink or an agent for a 2D or 3D print system. In other examples, the supply may be a digital titration cassette or a bio-print supply. The liquid supply 1 may hold a volume of liquid 5, from small volumes of several milliliters to larger volumes of several liters. In an example of a relatively large supply the supply 1 can be a buffer for a Continuous Ink Supply System, for example for a 2D or 3D inkjet-type print system.

The liquid supply 1 includes a reservoir 3. At least one wall defines an inner volume of the reservoir 3. In the illustrated example, the at least one wall includes at least one side wall 5, a top wall 7 and a base 9. The base 9 may be a bottom of the inner volume. The base 9 may be formed by a flat bottom, a sloped bottom, a tapered bottom, a gutter or a dent or the like. The at least one side wall 5 can include four straight walls or a single circumferential curved wall. The reservoir 3 has a liquid output to provide liquid to a liquid dispense system, for example directly fluidically connected to the base 9.

In the illustrated examples the reservoir 3 holds a liquid 11. The liquid level L1 in FIG. 1 is relatively high. In FIG. 1 more than half the inner volume of the reservoir 3 may be filled with liquid. In FIG. 2, the liquid level L2 is relatively low. For example the liquid level may have dropped to near the base 9. For example, the liquid volume in FIG. 2 may be less than 10% of the inner volume of the reservoir 3.

The supply 1 includes a liquid level sensor circuit 13. The liquid level sensor circuit 13 includes two elongated electrodes 15. The electrodes 15 extend in the inner volume of the reservoir 3 to contact the liquid 11. The electrodes 15 extend along a height H of the reservoir 3. The electrodes 15 may extend between the top wall 7 and the base 9 to sense liquid 11. In the illustrated examples the electrodes 15 extend up to a higher point above the top wall 7, for example to contact at least one of (i) a contact array for communicating signals to the liquid dispensing host device, (ii) a voltage source of the supply, and (iii) dedicated IC (integrated circuitry). In other examples the electrodes 15 could extend up to a lower point under the top wall 7 to start sensing liquid level only after a certain amount of liquid has exhausted. In again further examples separate conducting wires may contact the electrodes 15 to transmit signals to a further contact array or IC.

Near the base 9, the electrodes 15 are arranged to have increased sensitivity. In the illustrated example, the electrodes 15 are bent pins having a straight, upper portion 17 in an upper region 18 of the inner volume of the reservoir 3, and a sloped base portion 19 in a base region 20 of the inner volume of the reservoir 3. An extreme 21 of each electrode 15 may be located near the base 9 or touch the base 9. An electrode 15 that touches the base may prevent meniscus formation between the base 9 and an extreme of the electrode 15 when the liquid level drops below the electrode extreme.

The sensitivity of the electrodes 15 may be higher in the base portion 19 than in the upper portion 17, as is illustrated by FIG. 3. Such higher sensitivity in the base region 20 may facilitate a more accurate determination of a liquid level when the liquid level L2 is low, as compared to when the liquid level L1 is high. In one example this facilitates informing an end user relatively accurately about how many more pages or objects can be printed near exhaustion of a print cartridge. A point of transition C, or deflection point, of the electrode 15 between the upper and base portion 17, 19 of the electrode 15, may be closer to the base 9 than to the top 7 of the reservoir 3, for example such point C may extend at 40% of the height H of the inner volume of the reservoir 3 or lower, 30% of the height H of the reservoir 3 or lower, 20% of the height H of the reservoir 3 or lower, 10% of the height H of the reservoir 3 or lower, or 5% of the height H of the reservoir 3 or lower. Herein, a point of transition C may be a point where the electrode changes slope or transits from a straight to a curved shape; the height H of the reservoir inner volume may be measured between the base 9 and top wall 7 of the inner volume of the reservoir 3, and in case of absence of a top wall 7 the height H may be measured between the base 9 and a top edge of the side wall 5.

FIG. 3 plots a measured conductance of the sensor circuit 13 on a vertical axis, against liquid level on a horizontal axis. The liquid level increases along the horizontal axis from left to right. The conductance increases in a direction upwards along the vertical axis. Over the life of a supply, an output signal of the sensor circuit 13 may travel from right to left over the plot line, for example until the remaining liquid in the reservoir is close to zero whereby the output sensor signal may also reach approximately zero. For example, the liquid level may represent a remaining volume of liquid or a liquid surface height in the reservoir 3.

The plot line has a relatively large slope in a first region A that corresponds to a base portion 19 of the electrodes 15, that is, the plot line may be relatively steep in the first region A. The plot line has a relatively small slope in a second region 8 that corresponds to an upper portion 17 of the electrodes 15, that is, the plot line is less steep in the second region B than in the first region A. In the first region A, the large slope is indicative of a relatively large shift in conductance per unit of drop in liquid level. For example, in the first region A, for each height-unit (e.g. each mm) of decreasing liquid level, a conductance shift is larger than for each height-unit (e.g. each mm) of decreasing liquid level in the second region B. Hence, in the base region 20 small changes in the liquid level may be sensed more accurately as compared to the higher region 18, whereby remaining liquid level may be more accurately determined. The sensor signals may be associated with a remaining amount of at least one of liquid volume, liquid surface height, image area, pages, drops, objects, object volume, print jobs, etc. This can be communicated to an end user, for example through a controller and graphical user interface of a connected host device.

At least one of the electrodes 15 may be defined by monolithic, elongate, and at least partially bent or curved pins. In a further example such electrode pin is partially or completely made of metal lead frame.

The examples illustrate that the electrodes 15 are bent at a point of transition C. Other example electrodes may have a relatively smooth transition between an upper portion 17 and a base portion 19. For example such other example electrodes 15 may curve in the base region 20 of the reservoir 3. In both the bent and curved examples the sensitivity of the electrodes 15 is increased near the base 9 by an increasing electrode surface area that contacts the liquid per unit of height on a vertical axis.

Elevating liquid contacting electrode surface area per unit of height can be achieved by inclining or bending the electrode 15 as illustrated in multiple figures of this disclosure. For example, above point C, for each mm of liquid height a first surface area of the electrode 15 is in contact with the liquid. Below point C, for each mm of liquid height a second surface area of the electrode 15 in contact with the liquid is larger than the first surface area. The electrode surface area in contact with liquid, per mm of height along an upright axis, is larger near the base 9 because the electrode 15 is inclined near the base 9 while it is relatively straight in the upper region 18. A smaller slope of the electrode 15 results in a larger contact surface area with the liquid per unit of height along a vertical axis. In the upper region 18, the electrode 15 may be straight as illustrated in FIGS. 1 and 2, or at a minimum have a larger slope (i.e. be steeper) than in the base region 20. A larger slope of the electrode 15 of FIGS. 1 and 2 may result in a smaller slope of a plot line such as in FIG. 3. Hence, the slope and shape of the electrode 15 near the base 9 may be tuned to have a desirable sensitivity.

FIG. 3 illustrates that, by having a sensor circuit 13 that is more sensitive in the base region 20, in a lower volume range, whereby an upper liquid surface extends in the base region 20 (FIG. 2), a certain change in a magnitude of a sensor signal can be associated with a relatively small change in liquid volume. Then again, in a higher volume range, whereby the upper liquid surface is in the upper region 18 (FIG. 1), the same change in magnitude of a sensor signal can be associated with a higher change in liquid volume as compared to said lower volume range. While FIG. 3 plots a graph that facilitates determining a liquid volume based on conductance, the same principles may be applied in sensor circuits that sense through impedance, resistance or capacitance

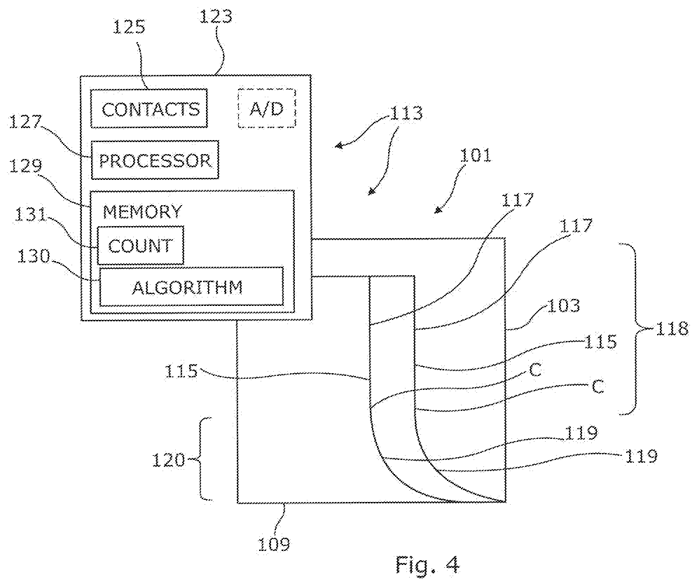

FIG. 4 illustrates an example of a liquid supply 101 that includes a reservoir 103 and a liquid level sensor circuit 113 to sense a level of liquid contained in the reservoir 103. In the illustrated example the sensor circuit 113 includes two electrodes 115. The electrodes 115 may extend along at least a part of the height of an inner volume of the reservoir 113. The electrodes 115 are curved near a base 109 of the reservoir 103 starting at a point of transition C between an upper portion 117 and a base portion 119 of the electrode 115.

The sensor circuitry 113 may include IC 123. The IC 123 may include a contact array 125 to transmit sensor signals, for example to and from a host device such as a liquid dispense system such as a printer. The contact array 125 may be configured to electrically connect to such host device. The contact array 125 may be defined by pads that are to contact contact-pins in the host device, which pins transmit signals to and from a host device controller. The contact array 125 may be configured to transmit digital signals, power signals, ground circuitry, analogue signals, etc., which signals may originate from or be transmitted from the supply IC 123. The signals may permit the host device to read a state of the supply, such as the sensed liquid level, and in addition an authenticity of the supply 101. In one example the power signals may be passed to the electrodes 115 through said contacts 125.

The IC 123 further includes a processor 127 or CPU that controls the operations on the IC 123, and a memory 129 that may be non-volatile and non-transitory. As per FIG. 3, a sensor signal such as a measured conductance can be associated with a remaining liquid amount. The memory 129 may store, or be configured to generate, a liquid level sensing algorithm 130 to associate measure sensor signals with liquid level. The algorithm 130 may include a signal-to-liquid-level conversion LUT (Look-Up-Table). Reservoir dimensions including a base floor shape may influence the remaining liquid amount, and said algorithm 130 for associating measured sensor signals with liquid level. At manufacturing stage the algorithm may be generated based on certain parameters such as reservoir dimensions. Irrespective of the reservoir dimensions, parameters that may influence the algorithm and/or LUT may include liquid type, electrode shape, electrode conductivity, etc. In other examples the algorithm and/or LUT may be stored or generated on a host device memory separate from the supply 101.

The algorithm is configured to instruct the processor 127 to, (i) in a lower volume range whereby an upper liquid surface is relatively close to the base of the supply reservoir, associate a certain change in a magnitude of a sensor signal with a relatively small change in liquid volume, and (ii) in a higher volume range whereby the upper liquid surface is further away from the base of the supply reservoir, associate the same change in magnitude of a sensor signal with a higher change in liquid volume as compared to the lower volume range. The lower volume range refers to having the liquid surface in the base region. The higher volume range refers to having the liquid surface in the upper region. The algorithm may be stored on the supply memory 129 and/or a host device memory, to instruct the supply processor 127 and/or a host device processor, respectively.

In one example, the memory 129 includes a count field 131 that includes a count value. The count value may relate to at least one of at least one of liquid volume, liquid surface height, pages, drops, objects, object volume, print jobs, etc. In one example the value in the count field 131 is updated by a printer controller, for example based on drop or page counts. In certain examples the count field is configured so that the count value only counts down, for example to zero, or only counts up for example up to a maximum value. The IC 123 may be configured so that the count field cannot be updated after reaching zero or the maximum value, respectively. In certain examples the count value may be updated or corrected based on measured values from the electrodes 115. For example the processor 127 of the supply or host device may be configured to compare (i) the count value and (ii) the measured sensor signal or liquid level, and to detect discrepancies between both values (i) and (ii). The processor may be configured to update the count value when detected discrepancies between the count value and the measured sensor signals do not exceed a predetermined threshold. In one example, the printer may determine the liquid level based on the count value. The processor may be configured to determine that a supply 101 is refilled if a detected discrepancy exceeds the predetermined threshold.

Other print related data such as a cartridge ID, authentication values, liquid type information, etc. may also be stored on the memory 129. At least two of the count value and other print supply related data, and the sensor signals may be communicated using the same contact array 125. The integrated circuitry could include an A/D converter to send digital sensor signals to the host device controller. In another example the sensor circuit 113 directly sends analogue sensor signals coming from the electrodes 115 to the host device.

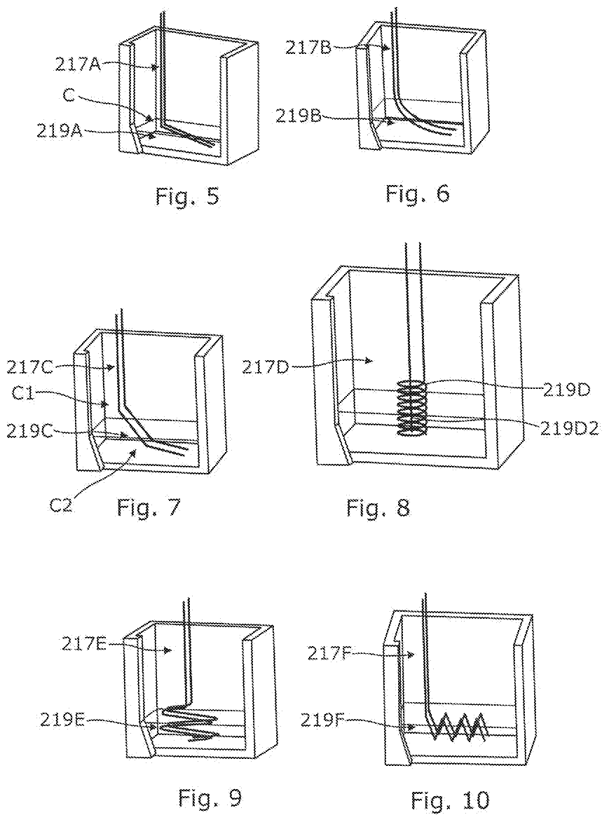

FIGS. 5-10 illustrated different examples of electrode pairs in reservoir housings, wherein a part of the reservoir housing is cut away for a view on the electrode pairs. Each housing and electrode pair is illustrated in an operational, upright position. Each electrode pair has a differently shaped base portion 219A-F. Each base portion 219A-F has more liquid contacting surface area per height-unit (e.g. mm) than the upper portion 217A-F. In the illustrated examples all electrode pairs have approximately straight upright upper portions 217A-F, at least in the operational upright orientation. The base portions 219A-F all have differently bent and/or curved shapes. The extremes of the base portions 219A-F may touch the base of the reservoir.

In FIG. 5 the electrodes are bent at a point of transition C. The base portion 219A has a relatively straight shape and is inclined with respect to the upright upper portion 217A. In different examples the angle between the base portion and the base can be between approximately 3 and approximately 70 degrees. The deflection point C may be round or sharp. In FIG. 6 the electrodes are curved in the base portion 219A. The curve may be a constant curve whereby a tangential of the electrode surface that has the biggest radius has a decreasing slope towards the base. In FIG. 7 the electrodes are deflected at a first point C1 and at a lower, second point C2. The base segments have different slopes. The slope with the base decreases towards to the base for each segment with respect to the previous segment. In other examples more segments could be formed in a similar manner. The points of transition C1, C2 may be rounded or relatively sharp. In FIG. 8 one of the electrodes has a curved base portion 219D while the other electrode has a substantially straight base portion 219D2. The curved base portion 219D extends at least partly around the straight base portion 219D2. The curved base portion 219D is spiraled and spirals around the straight base portion 219D2. In FIG. 9 the base portions 219E of the electrode pair include at least one S- or Z-shape. In FIG. 10 the base portions 219F of the electrode pair include at least one V- or W-shape.

In one example each electrode includes a metal or alloy, such as Fe—Ni (e.g. alloy 42), Ni, Cu, Cu—Fe, Cu—Zr, stainless steel, or the like. For example, the electrodes may have a coating or finishing layer of at least one of Cu, Au, ENIG, Ag, Ag—Ni, Cu OSP, or the like. In one example each electrode includes a metal lead frame, for example including one of the mentioned materials and/or other materials. The lead frame electrode may be manufactured by at least one of stamping, photo etching, EDM (electrical discharge machining), laser cutting, and other manufacturing methods. In different examples a cross sectional thickness along most of the length of such electrode can be between approximately 0.5 millimeters and approximately 4 millimeters.

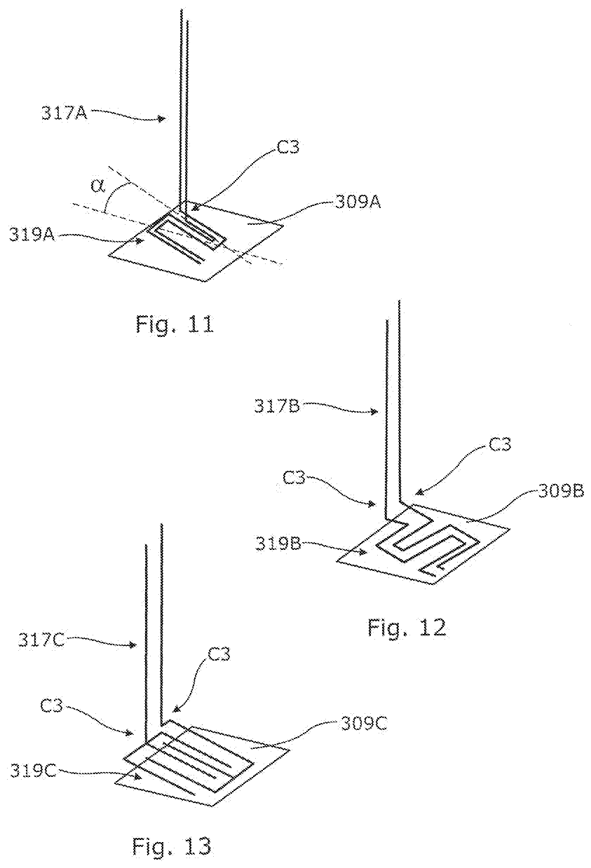

All electrodes of FIGS. 5-13 may be defined by monolithic, elongate, and at least partially bent or curved, pin shapes. The electrode shapes of each of FIGS. 5-10 could also be achieved including metal lead from in the electrodes. FIGS. 11-13 illustrate further examples of electrodes that could include metal lead frame.

FIGS. 11-13 illustrate electrode pairs of which each electrode has a substantially straight upper portions 317A-C and a sloped base portions 319A-C, with a point of transition C3 between the upper and base portion 317A-C, 319A-C. In one example, segments of the electrodes in the base portion 319A-C may extend in a plane that is sloped with respect to a base 309A-C wherein the plane have an angle α of approximately 3-70 degrees, or approximately 5-50 degrees with respect to the base 309A-C. For example, lower extremes of the base portions 319A-C may touch the base 309A-C or may fall a small distance short of touching the base portion 309A-C. The base portions 319A-C may be shaped as, for example, S-, Z-, E-, W-, U-, V-, N-, M- or T-shapes or other shapes, whereby base portion segments may be bent, curved or otherwise deflected and/or branched. The electrode segments in the base portion 319A-C may extend towards, parallel to, or away from, the base 309A-C. Said shapes, branches and/or direction-changes may permit a relatively high amount of electrode surface to contact liquid per height unit. Said shaped, branches and/or direction-changes may increase a sensitivity of the electrode as compared to a single pin electrode. Opposing electrodes in a single pair may have a slightly different shape to permit that they extend parallel to each other along their curvatures.

FIG. 11 illustrates base portions 319A having a S-shape, or reversed S- or Z-shape. Segments of the same single electrode extend parallel to each other in the base portion 319A. For the electrode pair, within a wider U- or n-Shape of one electrode extends another, narrower, U or n-shape of an opposing electrode so that the electrode wires extend parallel to each other. Between the deflection point C3 and the extreme end of the electrode, each electrode may have at least four deflection points or curves that deflect the electrode wire over at least approximately 90 degrees. FIG. 12 illustrates an example of again differently shaped electrode base portions 3198 having similar attributes as explained with respect to FIGS. 11-13, whereby between the point of transition C3 and the extreme each electrode can be deflected at least six times. The base portion may include an S-shape. FIG. 13 illustrates an example of yet again differently shaped electrode base portions 319C having similar attributes as explained above with respect to FIGS. 11-13, whereby one electrode is split into three branches. In other examples the electrode may be split into two or four or more branches. For example, a first forked electrode may branch of at the height of the point of transition C3. An opposing, also forked, electrode may include a single non-branched that slopes downwards along a segment wire of the first electrode, whereby the opposing electrode then branches off at a lower point near the base 309C whereby the branched segments are directed upwards between the branched segments of the first electrode, to extend parallel to and/or between the branched segments of the first electrode. In a similar manner, other example electrodes may be configured to have increased sensitivity in the base portion by including a plurality of differently sloped, curved and branched segments near the base.

In different examples of this disclosure, a liquid level may be defined by, or associated with, remaining liquid volume, liquid surface height, estimated remaining pages-to-print, estimated remaining drops-to-print, estimated remaining objects-to-print, estimated remaining object-volume-to-print, estimated remaining print jobs, etc. Some of the features discussed in this disclosure may facilitate a more accurate liquid level detection close to exhaustion, being able to indicate to an end user a relatively accurate approximation of at least one of remaining liquid volume, liquid surface height, estimated remaining pages-to-print, estimated remaining drops-to-print, estimated remaining objects-to-print, estimated remaining object-volume-to-print, estimated remaining print jobs, etc.

In further examples not explicitly described or illustrated in this disclosure more than two electrodes may be included in the liquid level sense circuitry of this disclosure. In further examples, reservoir walls that contact the liquid may be rigid whereby a bag or film may be provided inside the reservoir to compensate for backpressure changes in the reservoir during dispensing.

What is claimed is:

1. A liquid supply for supplying liquid in a liquid dispense system comprising
a reservoir to hold liquid,
a liquid level sensor circuit for measuring a liquid level in the reservoir comprising two electrodes extending into the reservoir along at least part of a height of the reservoir down to a base of the reservoir,
wherein the liquid level sensor circuit is arranged to have increased sensitivity near the base.

2. Liquid supply of claim 1 wherein, per unit of height, an electrode surface area in contact with liquid increases towards the base.

3. Liquid supply of claim 1 wherein the electrode is defined by a monolithic, elongated and at least partially bent or curved pin.

4. Liquid supply of claim 1 wherein a base portion of at least one of the electrodes touches the base of the reservoir.

5. Liquid supply of claim 1 wherein at least a base portion of the electrode that extends near the reservoir base has a sloped and/or curved shape.

6. Liquid supply of claim 5 wherein an upper portion has a less sloped and/or less curved shape than the base portion.

7. Liquid supply of claim 1 wherein a base portion of the electrode that has an increased sensitivity with respect to a remainder upper portion of the electrode covers less than 40% of the height of the electrode.

8. Liquid supply of claim 1 wherein the sensor circuit is to determine a liquid level through at least one of conductance, impedance, resistance and capacitance.

9. Liquid supply of claim 1 wherein the electrodes are composed of metal lead frame having a maximum cross sectional thickness of between approximately 0.5 and 40 millimeters.

10. Liquid supply of claim 1 wherein the supply further comprising integrated circuitry having a contact array to transmit both digital print-related signals and analogue or digital liquid level sensor circuit signals.

11. Liquid supply of claim 1 including a memory including an algorithm to associate sensor signals with liquid level, the algorithm being configured to instruct a processor to,
in a lower volume range whereby an upper liquid surface is relatively close to the base of the supply reservoir, associate a certain change in a magnitude of a sensor signal with a relatively small change in liquid volume, and
in a higher volume range whereby the upper liquid surface is further away from the base of the supply reservoir, associate the same change in magnitude of a sensor signal with a higher change in liquid volume as compared to the lower volume range.

12. Liquid supply of claim 1 including a processor and a memory wherein
the memory stores a count value that is to be associated with a liquid level, and
the processor is to change the count value based on at least one of drop count, page count and sensor signal values measured during printing.

13. Liquid supply of claim 1 wherein a base portion of at least one electrode includes a plurality of segments that are at least one of
differently curved,
differently sloped, and
branched off.

14. Liquid supply of claim 13 wherein the upper portion comprises a single straight pin-shape.

15. Liquid supply of claim 1 wherein the liquid is ink or 3D print agent and the supply is intended for replaceable interconnection with a 2D or 3D printer.
